(19) United States
(12) Patent Application Publication
(10) Pub. No.: US 2007/0074553 A1
(43) Pub. Date: Apr. 5, 2007

(54) Self-locking pin

(76) Inventor: Paolo Papaiz, Sao Paulo (BR)

Correspondence Address: Bliss McGlynn, P.C.;Suite 600, 2075 West Big Beaver Road, Troy, MI, 48084, US

(21) Appl. No.: 11/487,768

(22) Filed: Jul. 17, 2006

(30) Foreign Application Priority Data
Oct. 3, 2005 (BR) PI0504546-0

(51) Int. Cl. E05B 27/04

(52) U.S. Cl. 70/493

(57) ABSTRACT

The present invention refers to a novelty in the distribution of locking pins in locks and other systems that employ locking pins and unblocking keys that prevent the rotation of the wrong key. Additionally, they make the break-in action difficult.

The invention discloses a lock (1), provided with a rotating cylinder (2) receiving a key (3), the inner portion of the rotating cylinder (2) receives attenuating locking pins (4) that run supported by counter-locking pins inside grooves (6), being actuated by springs (7), in addition to one or more neutral pins (8) always positioned between the attenuating locking pins (4).

The neutral pin (8), under its normal condition, without being actuated by the key (3) or picklock (10), is aligned with the tangency line (9) of lock (1) and does not prevent, alone, the rotation of cylinder (2). Once a wrong key or picklock (10) is inserted into the rotating cylinder (2), the attenuating pins (4) are displaced so as to allow the rotation of cylinder (2) and the break-in of lock (1); however, the neutral pin or pins (8) are displaced downwards, crossing the tangency line (9), being actuated and preventing the rotation of cylinder (2) and the consequent break-in of lock (1).

### BACKGROUND OF THE INVENTION

1. Field of the Invention

The present invention refers to a novelty in the distribution of locking pins and neutral pins in locks and other systems the employ locking pins and unblocking keys that prevent the rotation of a wrong key. Additionally, they make the break-in action difficult.

2. Description of the Prior Art

In the current state of the art, several kinds of constructions and arrangements for locks and other systems employing locking pins and unblocking keys aiming the user security are known.

Usually, the intention is to make the lock break-in difficult as much as possible by using new mechanisms and technologies. To do so, more complex and highly expansive devices are used provided with a large number of elements and components that finally make the mechanisms unfeasible from the economic or even the technical point of view.

### SUMMARY OF THE INVENTION

In order to solve the drawbacks of the current art, the present invention discloses a novelty in self-locking pins for locks and other systems that employ locking pins and unblocking keys, where one or more neutral pins are provided, that is, without the action of the key, they do not lock the cylinder rotation but, when the wrong key or a master key or picklock is inserted, the pin or the neutral pins are compulsorily displaced, thus preventing the cylinder rotation.

### BRIEF DESCRIPTION OF THE DRAWINGS

The object of the present invention will be better understood based on the attached drawings, showed for illustration purposes and not to limit the invention, in which:

FIG. 1 is a sectioned view of a lock provided with the self-locking pins system of the present invention being actuated by a key;

FIG. 2 is a sectioned view of a lock provided with the self-locking pins system of the present invention being under rest;

FIG. 3 is a sectioned view of a lock provided with the self-locking pins system of the present invention during an attempt to be actuated using a master key or picklock.

### DESCRIPTION OF THE PREFERRED EMBODIMENT(S)

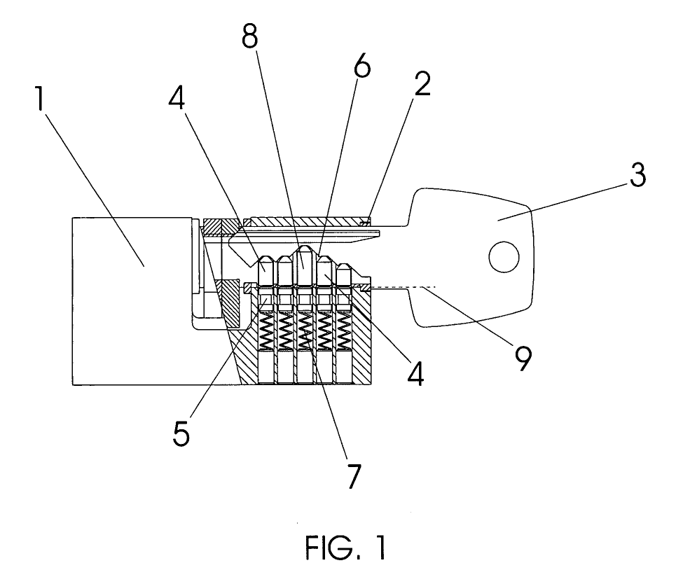

According to FIG. 1, it is seen that lock (1) is provided with a rotating cylinder (2) receiving a key (3).

The inner portion of the rotating cylinder (2) receives attenuating locking pins (4) that run supported by counter-locking pins (5) inside grooves (6), being actuated by springs (7).

Said rotating cylinder (2) is provided with one or more neutral pins (8) always positioned between the attenuating locking pins (4).

The rotation of cylinder (2) relative to the lock (1) may use, as a base, a tangency line (9). Whenever any pin crosses this tangency line (9) and is positioned between the rotating cylinder (2) and the lock (1), the rotation of cylinder (2) is prevented, thus avoiding any attempt to break in.

Thus, the use of neutral pins (8) between the attenuating pins (4) assures that a break-in attempt displaces the neutral pins (8) that lock the rotation of cylinder (2) relative to the lock (1).

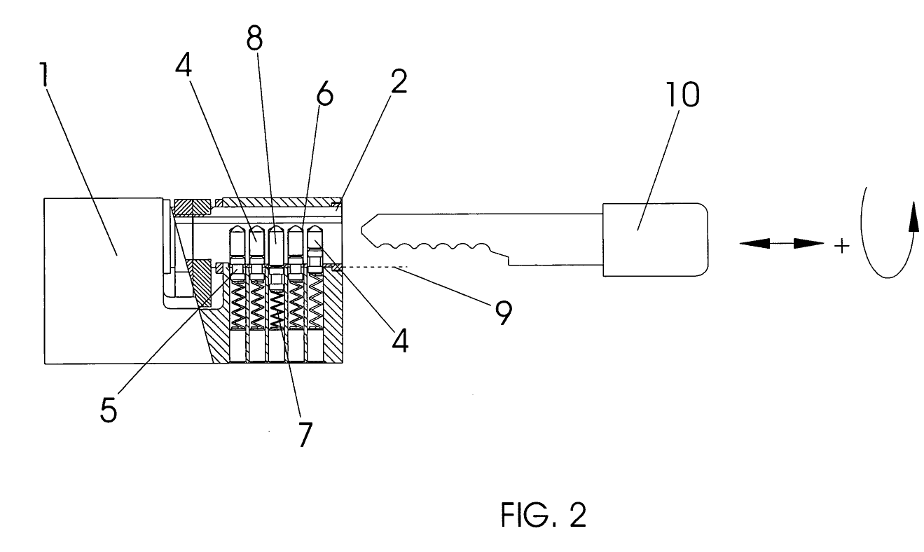

FIG. 2 is a sectioned view of lock (1) provided with neutral pins (8) of the present invention, just before the attempt to break in using a picklock or master key (10). Under this condition, it is seen that the neutral pin (8), under its normal condition, is aligned with the tangency line (9) of lock (1) and does not prevent, alone, the rotation of cylinder (2).

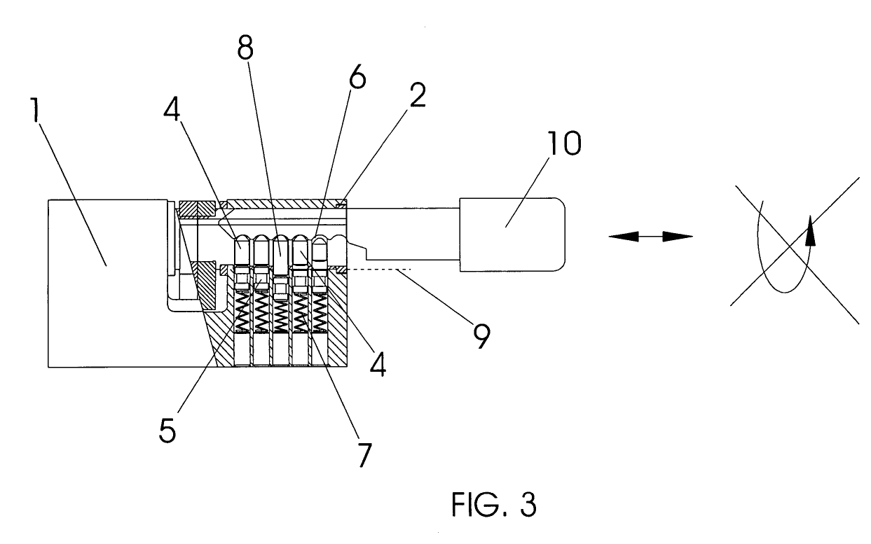

Once a picklock or master key (10) is inserted into the rotating cylinder (2), the attenuating pins (4) are displaced so as to allow the rotation of cylinder (2) and the break-in of lock (1); however, the neutral pin or pins (8) are displaced downwards, crossing the tangency line (9), being actuated and preventing the rotation of cylinder (2) and the consequent break-in of lock (1), since there is no room available for the picklock (10) to work. Under this condition, said neutral pins (8) leave the neutrality condition and start acting to prevent the rotation of cylinder (2), thus avoiding any break-in. This condition is clearly showed in FIG. 3, a sectioned vista of lock (1) with the master key or picklock (10) inserted into the rotating cylinder (2), thus preventing rotation by actuating the neutral pin or pins (8).

Thus, the present invention solves the drawbacks of the current art by disclosing a simple and effective mechanism providing the user with security and practicality.

What is claimed is:

1. “SELF-LOCKING PIN” used in locks and other systems using locking pins and unblocking keys (1), provided with a rotating cylinder (2) receiving a key (3), characterized in that the inner portion of the rotating cylinder (2) receives attenuating locking pins (4) that run supported by counter-locking pins (5) inside grooves (6), being actuated by springs (7), said rotating cylinder (2) is provided with one or more neutral pins (8) always positioned between the attenuating locking pins (4).

2. “SELF-LOCKING PIN”, according to claim 1, characterized in that the rotation of cylinder (2) relative to the lock (1) may use, as a base, a tangency line (9) and whenever any pin crosses this tangency line (9) and is positioned between the rotating cylinder (2) and the lock (1), the rotation of cylinder (2) is prevented.

3. “SELF-LOCKING PIN”, according to claim 1 or 2, characterized in that the neutral pin (8), under its normal condition, without being actuated by the key (3) or the picklock (10), is aligned with the tangency line (9) of lock (1) and does not prevent, alone, the rotation of cylinder (2).

4. “SELF-LOCKING PIN”, according to claim 1, characterized in that once a picklock or master key (10) is inserted into the rotating cylinder (2), the attenuating pins (4) are displaced so as to allow the rotation of cylinder (2) and the break-in of lock (1); however, the neutral pin or pins (8) are displaced downwards, crossing the tangency line (9), being actuated and preventing the rotation of cylinder (2) and the consequent break-in of lock (1).
